(19) United States
(12) Patent Application Publication
(10) Pub. No.: US 2015/0140427 A1
(43) Pub. Date: May 21, 2015

(54) Nanoporous Silicon Network Thin Films as Anodes for Lithium Ion Batteries

(71) Applicants: Xiang Zhang, Alamo, CA (US); Jia Zhu, San Jose, CA (US); Christopher Gladden, Aptos, CA (US); David Barth, Berkeley, CA (US)

(72) Inventors: Xiang Zhang, Alamo, CA (US); Jia Zhu, San Jose, CA (US); Christopher Gladden, Aptos, CA (US); David Barth, Berkeley, CA (US)

(73) Assignee: The Regents of the University of California, Oakland, CA (US)

(21) Appl. No.: 14/542,145

(22) Filed: Nov. 14, 2014

Related U.S. Application Data
(60) Provisional application No. 61/904,944, filed on Nov. 15, 2013.

(51) Int. Cl. H01M 4/38; H01M 4/04; C01B 33/02

(52) U.S. Cl. CPC H01M 4/386; C01B 33/02; H01M 4/044
USPC 429/218.1; 423/348; 428/220; 205/57

(57) ABSTRACT

Various embodiments of the invention describe nanoporous silicon (Si) network thin films with controllable porosity and thickness that are fabricated by a robust and scalable electrochemical process, and then released from Si wafers and transferred to flexible and conductive substrates. These nanoporous Si network thin films serve as high performance Li-ion battery electrodes, with an initial discharge capacity of 2570 mA h g⁻¹, above 1000 mA h g⁻¹ after 200 cycles without any electrolyte additives.

### CROSS REFERENCE TO RELATED APPLICATIONS

This U.S. Utility Application claims priority to U.S. Provisional Application Ser. No. 61/904,944 filed Nov. 15, 2013, which application is incorporated herein by reference as if fully set forth in their entirety.

### STATEMENT OF GOVERNMENTAL SUPPORT

The invention described and claimed herein was made in part utilizing funds supplied by the U.S. Department of Energy under Contract No. DE-AC02-05CH11231 between the U.S. Department of Energy and the Regents of the University of California for the management and operation of the Lawrence Berkeley National Laboratory. The government has certain rights in this invention.

### BACKGROUND OF THE INVENTION

1. Field of the Invention

The present invention relates to the field of Lithium ion batteries.

2. Related Art

Rechargeable lithium-ion batteries hold great promise as energy storage devices to solve the temporal and geographical mismatch between the supply and demand of electricity, and are therefore critical for many applications such as portable electronics and electric vehicles. Electrodes in these batteries are based on intercalation reactions in which Li+ ions are inserted (extracted) from an open host structure with electron injection (removal). However, the current electrode materials have limited specific charge storage capacity and cannot achieve the higher energy density, higher power density, and longer lifespan that all these important applications require. Silicon (Si) as an alloying electrode material is attracting much attention because it has the highest known theoretical charge capacity (4200 mA h g⁻¹). However, it is challenging to overcome the issues associated with alloying and conversion reactions, which involve large structure and volume changes (400% volume expansion for Si) during Li+ ion insertion and extraction. These issues can cause large hysteresis in the charge and discharge potentials, low power rate, and short cycle life, due to material instability, and poor electron and ion conduction.

Recently, Si nanostructures have been intensively explored to attack the volume expansion and fracture problem. For example, many Si nanostructures, such as Si nanowires, carbon/Si spheres, Si nanotubes, core-shell crystalline/amorphous Si nanowires, Si nanotubes, have also shown initial capacity close to the theoretical limit, good (>90%) capacity retention over a large number of cycles. However, low cost and fast throughput processes with great mass and morphology control are still desirable to reach the full potential for commercialization.

### BRIEF DESCRIPTION OF THE DRAWINGS

The foregoing aspects and others will be readily appreciated by the skilled artisan from the following description of illustrative embodiments when read in conjunction with the accompanying drawings.

FIG. 1 illustrates a nanoporous silicon (Si) network thin film fabrication process as shown.

FIG. 2 illustrates a porous layer transfer process that allows thin porous silicon thin film layers to be transferred to a variety of receiver substrates.

FIG. 3 illustrates an alternative embodiment utilizing light illumination.

FIG. 4 illustrates the dependence of porosity on illumination intensity. Inset: fourier transform infrared spectroscopy for porosity characterization.

FIG. 5 illustrates nanoporous Si network thin films before cycling a) top view SEM image, b) cross section SEM image, c) TEM image, inset: SAD pattern. Nanoporous Si network thin films (SEI has been removed) after cycling d) top view SEM image, e) cross section SEM image, f) TEM image, inset: SAD pattern.

FIG. 6 illustrates electrochemical characteristics of nanoporous Si network thin films tested between 1 V and 0.01 V. a), Delithiation capacity and CE of nanoporous Si network thin films at the charge/discharge rate of C/10 for the first 15 cycles, then at the charge/discharge rate of 1C until 200 cycles. b), Voltage profiles plotted for the 1st, 10th, 20^{th,} 100th and 200th cycles. c), Capacity of nanoporous Si network thin films cycled at various rates from C/20 to 2C. All the specific capacities of DWSiNTs are reported based on the total weight of Si—SiOx.

### DETAILED DESCRIPTION

In the discussions that follow, various process steps may or may not be described using certain types of manufacturing equipment, along with certain process parameters. It is to be appreciated that other types of equipment can be used, with different process parameters employed, and that some of the steps may be performed in other manufacturing equipment without departing from the scope of this invention. Furthermore, different process parameters or manufacturing equipment could be substituted for those described herein without departing from the scope of the invention.

These and other details and advantages of the present invention will become more fully apparent from the following description taken in conjunction with the accompanying drawings.

Various embodiments of the present invention describe a robust and scalable electrochemical process to fabricate electrodes comprising nanoporous Si network thin films with controllable porosity, which also demonstrate a high initial discharge capacity of 2570 mA h g⁻¹ and 200 cycles in electrochemical tests. These nanoporous Si network thin films also show a capacity of above 1000 mAhg⁻¹ beyond 200 cycles. Excellent rate capability is disclosed as well.

Nanoporous Si network thin films with controllable porosity and thickness are fabricated by a robust and scalable electrochemical process, and then released from Si wafers and transferred to flexible and conductive substrates. These nanoporous Si network thin films serve as high performance Li-ion battery electrodes, with an initial discharge capacity of 2570 mAh/g, above 1000 mAh/g after 200 cycles without any electrolyte additives. An embodiment also demonstrates that a certain oxide coating can be used to further improve the performance.

### Fabrication Process

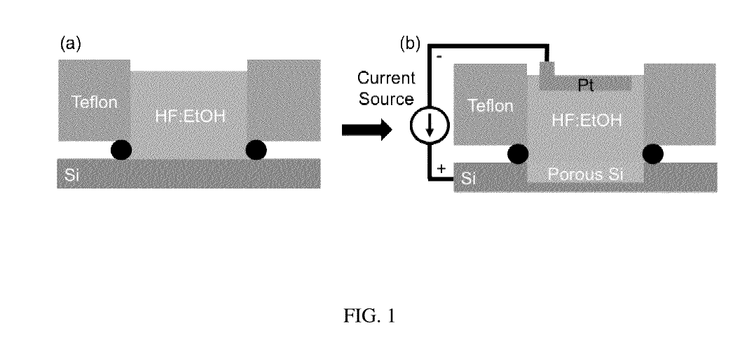

In one embodiment, a porous silicon thin film fabrication process is described as follows. To achieve high pore densities and uniform layers, a highly doped p-type wafer is selected. The wafers used have a resistivity approximately between 0.01-0.02 Ω cm which corresponds to a boron impurity concentration approximately between 3×10¹⁸-8×10¹⁸ cm⁻³. These wafers may be diced into one-inch chips and then loaded into a Teflon etching cell with an 18 mm diameter. The etching cell is held closed with three nylon screws, and sealed with a chemical resistant O-ring. The chamber is then filled with 49.5% hydrofluoric (HF) acid and ethanol (EtOH) in a ratio of 1:1 as shown in FIG. 1 (a). Next a constant current power source is attached to the etching cell, with the positive terminal connected to an aluminum foil electrode that contacts the backside of the silicon wafer, and the negative terminal is connected to a platinum ring electrode that sits at the top of the solution as shown in FIG. 1 (b).

FIG. 1 illustrates the porous silicon process, (a) the etching chamber is filled with a mixture of 3:1 HF:EtOH and sealed with a rubber O-ring, (b) a constant current source is attached to the cell, with the positive terminal connected to an aluminum electrode on the backside of the silicon wafer, and the negative terminal is connected to a platinum ring electrode at the top of the solution. The current is applied to a set time and a porous silicon layer is created.

As current flows through the cell, holes are driven to the surface of the silicon at the semiconductor/electrolyte interface. When these holes reach the surface, they effectively oxidize the surface silicon atoms by removing electrons, at which point the silicon atom(s) is dissolved into a silicon hexafluoride ion by the surrounding fluoride in a reaction given by:

2 h⁺+6 HF+Si→SiF₆²⁻+H₂+4 H⁺

This reaction proceeds in such a way that the holes are preferentially driven towards the existing etch sites, resulting in the creation of pores. For a typical etching current of 280-600 mA/cm² the etching process is allowed to proceed for 15-120 seconds, depending on the desired thickness. For high etching currents (>1300 mA) the maximum etching time is greatly reduced to prevent the destruction of the porous network. After etching, the cell is rinsed 4 times with ethanol to remove the residual HF, and then dipped in hexane and air-dried. The hexane reduces the surface tension during drying and reduces the risk that the porous network will collapse. While critical point drying can be used, hexane drying provides comparable results with significantly less time required.

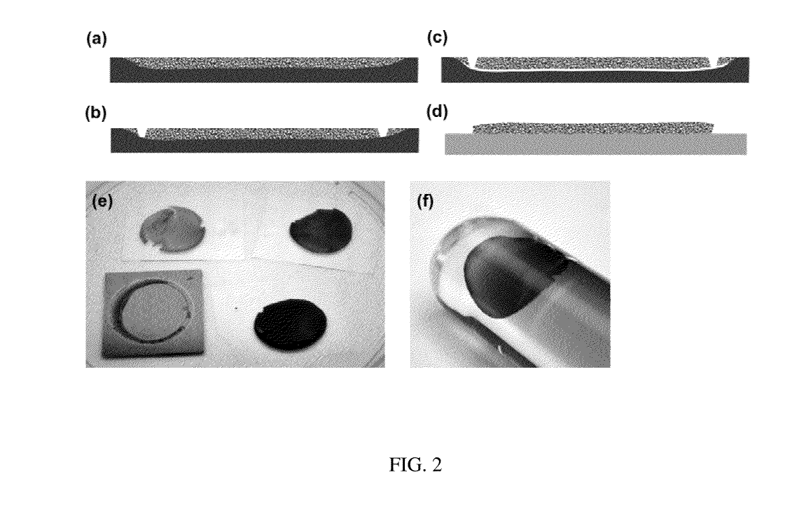

If we apply this concept to our porous silicon layers, we can see that by adjusting the HF concentration, we can switch between pore formation and electropolishing. The result of this is that a thin film of porous silicon can be undercut and freed from the silicon substrate, and then transferred to any type of receiver substrate. This process is shown schematically in FIG. 2(a)-(d). First a porous layer is etched into the silicon wafer, then using a diamond scribe or other sharp implement a region around the porous layer is mechanically scored to define the outline of the layer that will be lifted off. This outline can be drawn either with solution in the cell or with a dry cell. It is also possible to skip the mechanical scoring step if the electropolishing process is allowed to continue for an extended period of time, usually greater than 10 minutes. After scoring, the chamber is filled with 20:1 ethanol:HF solution and etched at high voltage for 2-10 minutes. This electropolishing step removes all the connections between the porous layer and the substrate except for very near the edges, which is why scoring the edges is important. During the electropolishing it is possible for trapped gas bubbles to form underneath the porous layer. It is important to very carefully remove such bubbles, as the rupturing of one will destroy the thin porous material. After the electropolishing step the chamber is carefully drained and rinsed with pure ethanol several times to remove the residual hydrofluoric acid. Finally the free porous layer can be carefully transferred to a receiver substrate by slowly flowing ethanol over the chip and allowing it to slide into position on a new substrate.

One large advantage of the porous layer transfer technique is that the silicon wafer can be reused many times. After the electropolishing step (which only removes a trivial amount of silicon) the wafer is ready for another porous layer to be formed. FIG. 2(e) shows the results of a series of etches performed on the same wafer, with each porous layer having a different thickness and porosity. It is also possible to transfer the porous layers to curved substrates, as shown in FIG. 2(f).

FIG. 2 illustrates that the porous layer transfer process allows thin porous silicon layers to be transferred to a variety of receiver substrates. A porous layer is etched and removed from the etching cell (a). A carbide pencil is used to draw a circle around the edge of the porous layer. This optional step reduces the difficulty in removing the porous layer and results in a more uniform layer since the edges are excluded. The chip is then returned to the etching cell and a high bias is applied in a very dilute HF:Ethanol mixture (1:20) to electropolish underneath the porous silicon layer. This process is allowed to proceed since very little etching occurs in the porous network itself, since it is significantly less conductive than the bulk silicon. Finally the substrates are rinsed multiple times and then transferred to a receiver substrate using any of a variety of methods (d). A single silicon wafer can be used to produce many different porous silicon layers as shown in (e), where a single chip of silicon was used to produce all three porous layers pictured. The porous layers are flexible and can easily be transferred to curved surfaces as seen in (f).

Once the porous layer has been transferred to an appropriate substrate, drying is the most critical procedure. Depending on the amount of adhesion between the substrate and the porous layer, allowing the layer to air dry may result in peeling or cracking. To prevent this, a superior solvent such as hexane can be used, or a supercritical drying step may be required. In most cases where the receiver substrate is clean and smooth, the adhesion is sufficient to prevent the porous layer from being removed under any normal stresses.

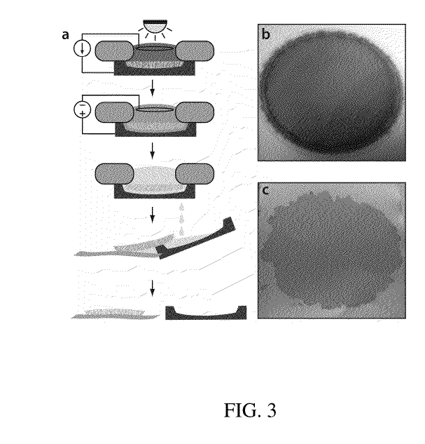

In an alternative embodiment, FIG. 3 illustrates a) schematics of fabrication process flow. The nanoporous film is first etched in 3:1 HF:EtOH under light illumination, then undercut in 20:1 HF:EtOH. After being rinsed in EtOH it can be transferred to Cu foil and the substrate is reused. b) Nanoporous Si film on Si substrate. c) Nanoporous Si film transferred to Cu film.

Silicon wafer chips (0.01-0.02 Ω-cm p-type) are secured in a teflon etch cell filled with a 1:3 hydroflouric acid and ethanol mixture. A nanoporous Si thin film is etched under constant current and light illumination.

Subsequently the solution is exchanged for 1:20 HF:EtOH and etched at 30 V to undercut the porous network and release it from the silicon substrate. Finally the etch cell is flushed with pure ethanol, and then the thin layer of nanoporous Si is transferred to Cu foil by slowly flowing ethanol over the chip while holding it in contact with the foil. The porous layer on Cu foil is then rinsed with hexane and allowed to air dry. The silicon substrate can be reused many times, ensuring efficient use of the Si source material.

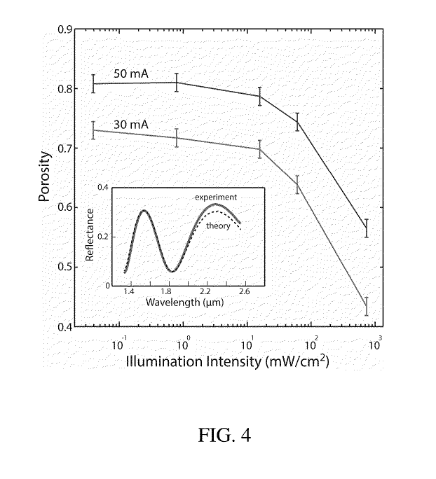

FIG. 4 illustrates the dependence of porosity on light illumination intensity. Inset: fourier transform infrared spectroscopy for porosity characterization.

The porosity of these nanoporous Si network thin films can be controlled by adjusting the etching current and light illumination intensity (FIG. 4). Increasing etching current uniformly increases the porosity of the network, while increasing light illumination intensity decreases the porosity of the network. The porosity is measured using FTIR reflectance spectroscopy which is then fitted using the dispersion of silicon and effective medium theory to calculate the refractive index and corresponding porosity (FIG. 4 inset).

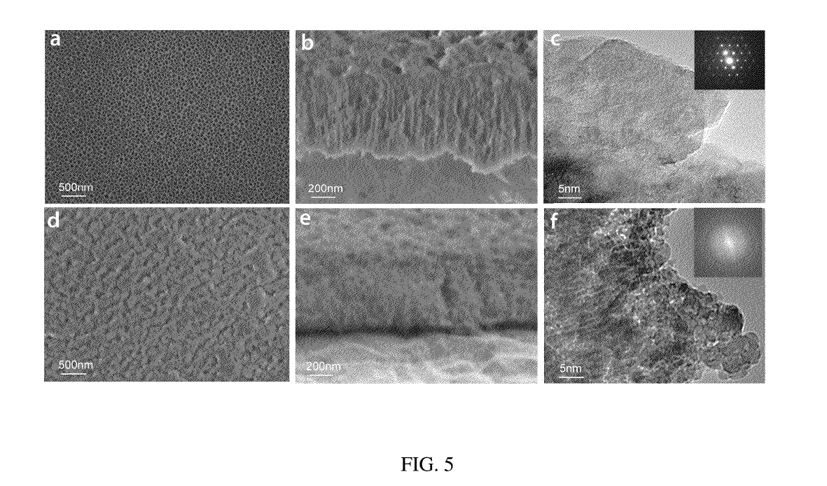

FIG. 5 illustrates nanoporous Si network thin films before cycling a) top view SEM image, b) cross section SEM image, c) TEM image, inset: SAD pattern. Nanoporous Si network thin films (SEI has been removed) after cycling d) top view SEM image, e) cross section SEM image, f) TEM image, inset: SAD pattern.

We assume the porosity is uniform along the thickness direction, which can be seen in FIGS. 5b and 5e. To increase the accuracy of the model, the layer thickness is measured using SEM cross-section and compared to the model fitting.

To investigate the electrochemical performance of these nanoporous Si network thin films, two-electrode 2032 coin cells with these nanoporous Si network thin films (˜20 nm pore size) on the Cu substrate were fabricated with Li metal as the counter electrode. As the volume of Si will expand upon the full lithiation to 400% of the original, samples with 80% porosity were used in this study. To understand the intrinsic properties of these nanoporous Si network thin films, galvanostatic cycling was used with voltage cutoffs of 0.01 and 1V vs Li/Li+. The charge capacity referred to here is the total charge inserted per unit mass of the nanoporous Si network thin films during Li insertion, whereas the discharge capacity is the total charge removed during Li extraction.

The structural changes of the nanoporous Si network thin films before and after lithiation were studied using scanning electron microscopy (SEM), and transmission electron microscopy (TEM). The as-fabricated nanoporous Si network thin films have an average pore size of 20 nm and 1 um thickness as revealed in SEM images (FIG. 5a). Cross-section SEM showed the whole porous Si network thin films are well contacted to the Cu substrate (FIG. 5b), which is crucial for battery performance. The as-fabricated nanoporous Si network thin films were single crystalline, as confirmed by TEM (FIG. 5c). As shown in FIG. 5f, The nanoporous Si becomes predominately amorphous during electrochemical cycling, similar to what has been observed in SiNWs. SEM (FIG. 5e) studies found that the network thin films remained adhered to the substrate. The pore size of the network thin films also appears to have decreased after lithiation, as expected from the predicted volume change. It is important to note that the network thin films do not pulverize after cycling because of the large porosity which can accommodate the volume change, as shown in FIGS. 5 d and e.

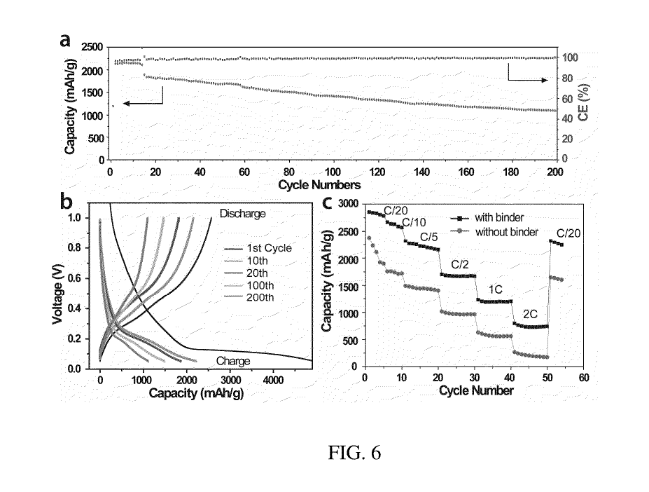

FIG. 6 illustrates electrochemical characteristics of nanoporous Si network thin films tested between 1 V and 0.01 V. a), Delithiation capacity and CE of nanoporous Si network thin films at the charge/discharge rate of C/10 for the first 15 cycles, then at the charge/discharge rate of 1C until 200 cycles. b), Voltage profiles plotted for the 1st, 10th, 20^{th}, 100th and 200th cycles. c), Capacity of nanoporous Si network thin films cycled at various rates from C/20 to 2C. All the specific capacities of DWSiNTs are reported based on the total weight of Si—SiOx.

The first discharge capacity was 2570 mAh/g at the C/10 rate, or 10h per half-cycle (FIG. 6a). The irreversible capacity loss is likely due to reactions at the surface of these nanoporous structures. One possibility is the formation of a surface-electrolyte interphase (SEI) film due to electrolyte decomposition. This has been well studied in both carbonaceous and Si electrodes. The second possibility is the decomposition of the native oxide that forms on the Si. The low Coulombic efficiency is limited to the first cycle, suggesting that any surface reactions occur only during the initial cycling. More studies will be done to determine the exact processes and the origin of the large initial irreversible capacity loss. The Coulombic efficiency starting from for the 2nd cycle is above 97%, showing excellent reversible cycling after the surface reactions are completed. The discharge capacity remains stable at 1800 mAh/g over 20 cycles (FIG. 6a), indicating that the nanoporous Si network thin films remain contacted to the current collector and do not undergo pulverization.

The voltage profiles of the different cycles are shown in FIG. 6b. The lithiation potential shows a sloping profile between 0.1 and 0.01 V, consistent with the behaviour of amorphous silicon. No obvious change in charge/discharge profile can be found after 200 cycles, indicating superior and stable cycling performance. This long cycle life without any electrolyte additive can be attributed to the stable SEI and materials in the nanoporous Si materials.

High rate capabilities were also observed in the nanoporous Si network thin films (FIG. 6c). Charging/Discharging at C/20, C/10, C/5, C/2, 1C and 2C revealed good cyclability. The Coulombic efficiency of 99.7% was also quite high, indicating excellent reversibility. The capacity was very stable at the high rates, indicating good Li diffusivity in the Si. Although the capacity dropped at the 1 C rate to 1200 mAh/g, it was still much higher than the theoretical capacity of graphite (372 mA âh/g). Also it is found that addition of binder (CMC binder) can improve the performance, which has been reported before. In the case of Si-C composite, it is reported that the addition of a binder can improve the performance by holding the active materials together. However, in this study, since the nanoporous Si network thin films did not pulverize after electrochemical cycling, it is believed that the binder improves the performance by improving the electrical contact between active materials and current collectors.

In conclusion, various embodiments have shown that nanoporous Si network thin film anodes with 80% porosity have a high specific capacity (2570 mAh/g) and excellent cycling performance (>200 cycles) without any electrolyte additives. Our nanoporous Si anode design is easy to fabricate and has good electronic contact between the network and the current collector. Thus, nanoporous Si network thin films can be a promising, higher-capacity alternative for the existing graphite anode in Li ion batteries.

We claim:

1. A composition of matter comprising:
a nanoporous silicon (Si) network thin film.

2. The composition of claim 1, wherein a pore size of the thin film is approximately uniform.

3. The composition of claim 1, wherein the thin film comprises approximately 0.01-0.02 Ω-cm p-type silicon.

4. The composition of claim 1, wherein the thin film comprises a boron impurity concentration of approximately 3×10¹⁸-8×10¹⁸ cm⁻³.

5. The composition of claim 1, wherein the thin film comprises single crystalline silicon.

6. The composition of claim 1, wherein an average pore size is between 10 nm to 30 nm.

7. The composition of claim 6, wherein the average pore size is approximately 20 nm.

8. The composition of claim 1, wherein an average thin film thickness is approximately between 0.5 um-1.5 um.

9. The composition of claim 8, wherein the average thin film thickness is approximately 1 um.

10. The composition of claim 1, wherein an average porosity is approximately between 70% to 90%.

11. The composition of claim 10, wherein the average porosity is approximately 80%.

12. An electrode comprising:
a current collector; and
a nanoporous silicon (Si) network thin film in contact with the current collector.

13. A battery comprising:
an anode comprising a current collector and a nanoporous silicon (Si) network thin film in contact with the current collector; and
a cathode.

14. The battery of claim 13, wherein a specific capacity is approximately 2570 mAh/g.

15. The battery of claim 13, wherein a coulombic efficiency is approximately 96 to 99.9%.

16. The battery of claim 13, wherein a discharge capacity is approximately 1800 mAh/g.

17. A method of manufacturing a nanoporous silicon (Si) network thin film comprising:
providing a doped p-type silicon substrate;
providing a constant current power source in electrical contact with the doped p-type silicon substrate;
etching the doped p-type silicon substrate in a hydrofluoric (HF) acid and ethanol (EtOH) solution for a predetermined etching time period at a predetermined etching electrical current and voltage to produce the nanoporous Si network thin film; and
transferring the nanoporous Si network thin film to a receiver substrate.

18. The method of claim 17, further comprising providing a light illumination to control a porosity of the nanoporous Si network thin film.

19. The method of claim 18, wherein the porosity of the nanoporous Si network thin film is controlled by adjusting an etching current and a light illumination intensity.

20. The method of claim 19, wherein increasing an etching current uniformly increases the porosity, while increasing the light illumination intensity decreases the porosity of the nanoporous Si network.

21. The method of claim 17, further comprising rinsing the doped p-type silicon substrate with ethanol to remove residual HF, followed by submersion in hexane and air-drying.

22. The method of claim 17, further comprising providing an approximately 20:1 ethanol:HF solution and etching at an increased voltage for approximately between 2-10 minutes to undercut the nanoporous Si network thin film to and cause separation from the doped p-type silicon substrate.

23. The method of claim 22, further comprising etching at approximately 30 volts to undercut the nanoporous Si network thin film.

24. The method of claim 17, wherein the etching current is approximately between 280-600 mA/cm² and the etching time is approximately between 15-120 seconds.

25. The method of claim 17, wherein the hydrofluoric (HF) acid and ethanol (EtOH) solution is approximately 3:1 HF:EtOH.

26. The method of claim 17, wherein the doped p-type silicon substrate comprises a resistivity of approximately between 0.01-0.02 Ω cm and a boron impurity concentration of approximately between 3×10¹⁸-8×10¹⁸ cm⁻³.

27. The method of claim 17, wherein the constant current power source is in electrical contact with the doped p-type silicon substrate with a positive terminal connected to an electrode that contacts a backside of the doped p-type silicon substrate, and a negative terminal is connected to an electrode that is positioned approximately at a top portion of the solution.

28. The method of claim 27, wherein the positive terminal is connected to an aluminum foil electrode and the negative terminal is connected to a platinum ring electrode.
